(19) United States
(12) Patent Application Publication
(10) Pub. No.: US 2008/0078562 A1
(43) Pub. Date: Apr. 3, 2008

(54) Universal glue-on horseshoe assembly

(75) Inventors: William J. Kirkpatrick, West Chester, PA (US); Mary S. Hazzard, Unionter, PA (US)

Correspondence Address: WERNER & AXENFELD, LLP, P. O. BOX 1629, WEST CHESTER, PA, 19380, US

(73) Assignee: Sound Horse Technologies, LLC

(21) Appl. No.: 11/542,381

(22) Filed: Oct. 3, 2006

(51) Int. Cl. A01L 7/02

(52) U.S. Cl. 168/14

(57) ABSTRACT

An assembly for attaching a horseshoe to a horse's hoof is described. The assembly is adjustable in both size and shape to conform to most horse shoe sizes and shape configurations. The horseshoe assembly includes an elastomeric rim pad, a fabric cuff, and a plate. The elastomeric rim pad has an upper surface which is coextensive with an outer bottom periphery of a horse's hoof. The fabric cuff is partially cast into the elastomeric rim pad, and is configured to conform to a wall of a horse's hoof and attach thereto through the use of an adhesive. A plate is secured to a lower surface of the elastomeric rim pad, the plate comprised of a bendable material which is adjustable in shape to conform in shape and size with a horseshoe selected from a group of horseshoes having different shapes and sizes. The plate is attached to the selected horseshoe.

### TECHNICAL FIELD

This invention relates to an assembly for securing a horseshoe to a horse's hoof using adhesive rather than nails.

### BACKGROUND

Horseshoes come in a variety of sizes and shapes depending on the type of horse and activity for which the horse is to be engaged. Generally horseshoes are U-shaped and conform to the circumference of the hoof with two branches emanating from the toe area and projecting beyond the heel. Typically, the horseshoe is nailed to the hoof. Every four to six weeks due to the growth of the horse's hoof, the shoe is removed and the hoof trimmed.

There are drawbacks associated with nailing horseshoes directly to the hoof of a horse. Some problems encountered when using nails for securing horseshoes to a horse's hoof include, sore hoofs, infections, cracked hoof walls, accidental nailing into fleshy areas of the hoof, and dislodging of nails into the fleshy part of the hoof.

Another drawback with conventional horseshoes that are nailed-on is that they offer little or no absorption of shock from concussion when a horse moves, especially when carrying or pulling weight.

Attempts have been made to glue horseshoes directly to a horse's hoof to solve, in part, some of the problems associated with using nail-on shoes. For example, a “direct glue method,” involves a farrier applying glue (an acrylic, urethane or similar material) to the outer periphery of the bottom of the horse's hoof, and to the horseshoe, and then placing the shoe against the bottom of the hoof. The shoe will, supposedly, be firmly attached to the hoof. In actuality, to obtain an adequate adhesive bonding surface area, the farrier must also apply glue to the heels, and some of the sensitive sole of the hoof thereby firmly attaching the shoe to the horse's heels. This severely restricts and/or eliminates the heel action or movement that is part of the natural suspensory and shock absorbing mechanism of the horse. The result of this direct glue method attachment is that a hard and rigid shoe is attached to the hoof by be means of a hard and rigid adhesive bond. This broad area of non-mechanical attachment eliminates the natural motion of the hoof, especially at the heel. Such restrictions on the natural movement of the hoof frequently results in heel or sole bruising sometimes causing hoof soreness or laming and results in pain and/or reduced animal performance.

Recently, attempts have been made to avoid many problems associated with nailing shoes onto a horse's hoof, and the direct glue method. For example, U.S. Pat. No. 5,330,008 to Sigafoos et al. (incorporated herein by reference in its entirety)(referred to herein as the Sigafoos Patent) describes a technology for securing conventional horseshoes to a horse's hoof by means of adhesives that does not restrict the natural movement of the heel. In a commercial implementation, Soundhorse Technologies of Unionville, Pa., U.S.A., presently manufactures a glue-on shoe system product known as the Sigafoos Series™ I horseshoe system that avoids many of the problems associated with nail-on shoes and the direct glue method. It uses a fabric collar embedded around the edges of the horseshoe, which is used to attach the shoe to the horse's hoof on the hoof wall.

A drawback, however, with present glue-on shoe systems is that the horseshoe is irrevocably attached to the fabric cuff system. That is, a specific horseshoe shape and specific horseshoe size is permanently attached to the glue-on system cuff system. The cuff system arrives at a customer's site from a factory as fully integrated product with a shoe permanently affixed to the system cuff using urethane and other materials. Such a shoe system cannot be hot forged or welded or undergo any extra heating, as this will destroy the urthethane bond attaching the shoe to the cuff system.

As a result, a farrier has to plan ahead to have the exact shoe and size available for the individual horse. This is frequently not practical as most farriers have to arrive at a horse's location, access the hooves of the horse, and choose shoe configurations and sizes, and then shape the shoes before attaching to the horse's hoof. Thus, most glue-on horseshoe systems are not readily used by farriers due to the inconvenience of having only limited quantities of particular sizes and configurations available.

### SUMMARY

Described herein is a horseshoe assembly for attaching a horse's hoof to a horseshoe using an adhesive, such as glue. The assembly is adjustable in both size and shape to conform to most horse shoe sizes and shape configurations. This provides a farrier (a person that shoes horses) with the ability to select a horseshoe that he/she believes best matches a horse's hoof; adjust the size and shape of the assembly to match the selected horseshoe; attach the assembly to the selected horseshoe using an adhesive; and then glue the assembly with the horseshoe secured thereto onto the horse's hoof, while avoiding the deleterious problems of a “direct glue method” mentioned above.

In accordance with an aspect of the invention, the horseshoe assembly includes an elastomeric rim pad, a fabric cuff, and a plate. The elastomeric rim pad has an upper surface which is coextensive with the lower bottom periphery of a horse's hoof for attachment thereto through the use of an adhesive. The fabric cuff is secured to the elastomeric rim pad, and is configured to conform to a wall of a horse's hoof and attach thereto through the use of an adhesive. A plate is secured to a lower surface of the elastomeric rim pad, the plate comprised of a bendable material which is adjustable in shape to conform in shape and size with a horseshoe selected from a group (i.e., a full array) of horseshoes having different shapes and sizes.

In accordance with another aspect of the invention, the plate serves as an interface for securing a horseshoe to the hoof assembly (e.g. the elastomeric rim pad and the fabric). That is, the plate is a thin U-shaped material having an upper surface secured to the hoof assembly, and a lower surface for securing to the horseshoe. The plate is formed of a bendable material which is adjustable in shape to be coextensive (i.e., sharing many of the same boundaries) with a selected horseshoe.

In accordance with yet another aspect of the invention, the plate is segmented or notched to provide the farrier with the ability to easily bend the hoof assembly to match the shape configuration of a selected horseshoe. And once bent into a shape selected by the farrier, the segmentation is such that it also provides the plate with the ability to hold the shape selected while resisting the propensity of the elastomeric rim pad to return to its original cast shape after being flexed. The segmentation of the plate also provides pockets between which acrylic or other adhesive can flow to attach the horseshoe to the assembly. These pockets also serve as lateral friction points between the horseshoe and the plate, after the horseshoe is attached to the assembly and the adhesive cures. Segmentation of the plate may be achieved using a variety of patterns, including slots, slits, holes, or any suitable combination of segmentation patterns, which are molded, forged, stamped or cut into the plate.

Thus, in accordance with the present invention a substantial advantage is achieved by a glue-on horseshoe assembly that is not irrevocably attached to a horseshoe and can be used with any horseshoe selected from a group of horseshoes having a wide variety of different shape and size configurations. The invention, therefore, provides a farrier with the ability to assess a horse's hoof, select a shoe shape, select a shoe size, and then attach the hoof assembly thereto on site. The ability to adjust the assembly in size and shape to conform to the selected horseshoe provides greater flexibility for a farrier that desires to glue horseshoes onto a horse.

Additional exemplary implementations and features/advantages are described in the Detailed Description in conjunction with the accompanying drawings below. The scope of the invention is recited in the Claims.

### BRIEF DESCRIPTION OF THE DRAWINGS

The detailed description is explained with reference to the accompanying figures. In the figures, the left-most digit(s) of a reference number identifies the figure in which the reference number first appears. It should be noted that the figures are not necessarily drawn to scale and are for illustration purposes only.

FIG. 1 is a side view of a horseshoe assembly for attaching a horseshoe to a horse's hoof in accordance with the invention.

FIG. 2A shows a top view of the horseshoe assembly shown in FIG. 1.

FIG. 2B shows a bottom view for the horseshoe assembly of the invention in which U-shaped members comprising the horseshoe assembly are bent in shape configuration to correspond with a horseshoe (not shown) that has a similar shape configuration.

FIG. 3 shows an isometric view of a portion of the rim pad.

FIG. 4 shows a top view of an exemplary implementation of a plate.

FIG. 5 shows a method for attaching a horseshoe assembly to a horseshoe.

FIG. 6 shows a side view of the horseshoe assembly secured to a horse's hoof.

FIG. 7 shows a top view of an exemplary implementation of a plate having separate sections rather than a single unitary piece of material as shown in FIG. 4.

### DETAILED DESCRIPTION

Introduction

Reference herein to “one embodiment”, “an embodiment”, “an implementation” or “one implementation” or similar formulations herein, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

In the following description, for purposes of explanation, specific numbers, materials and configurations are set forth in order to provide a thorough understanding of the present invention. However, it will be apparent to one skilled in the art that the present invention may be practiced without each specific example. In other instances, well-known features are omitted or simplified to clarify the description of the exemplary embodiments of the present invention, and thereby, to better explain the present invention.

The inventors intend these embodiments and implementations to serve as representative illustrations and examples. The inventors do not intend these embodiments to limit the scope of the claims; rather, the inventors have contemplated that the claimed invention might also be embodied and implemented in other ways, in conjunction with other present or future technologies.

As used herein the term “horse” refers to any hoofed animal in the equine family or others that may wear shoes that attach to their hoofs, such as a horse, a pony, a donkey, a mule, a cow, a giraffe, or other animals having keratinous hoof materials.

### Exemplary Universal Glue-On Horseshoe Assembly

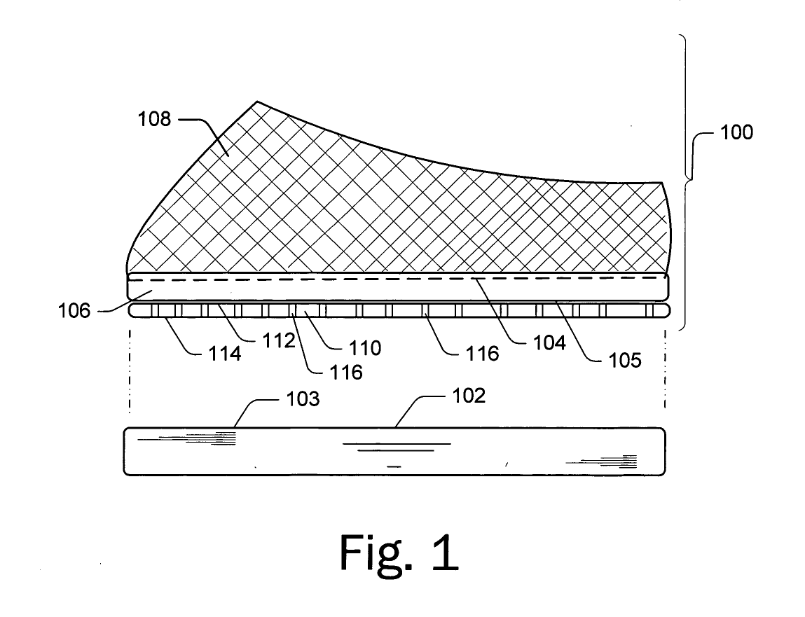

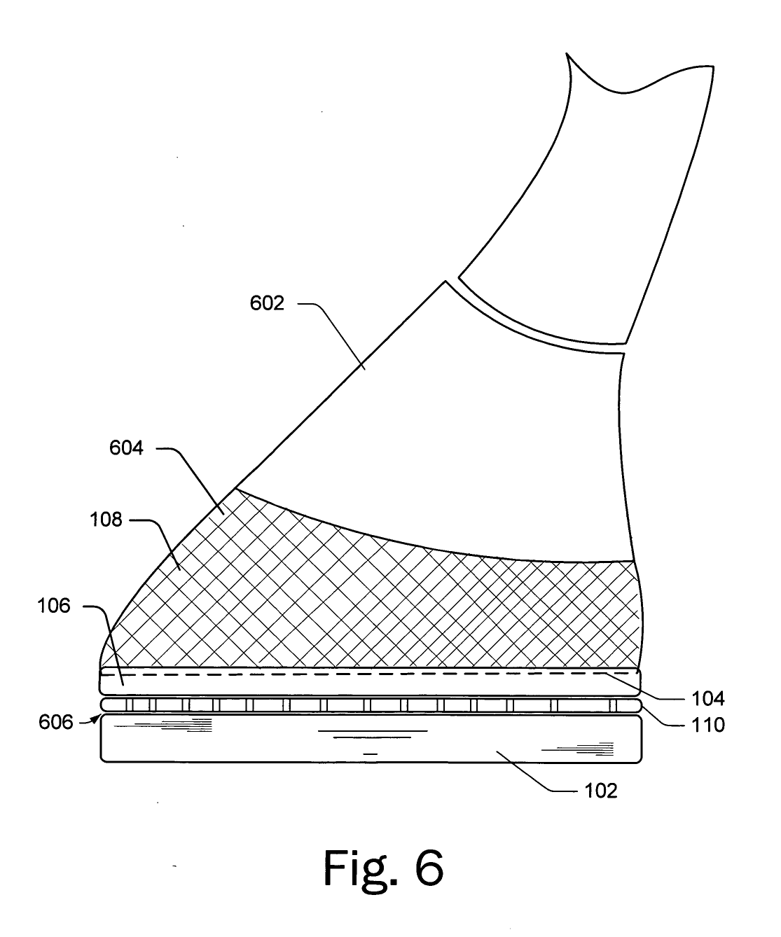

FIG. 1 is a side view of an assembly 100 for attaching a horse's hoof to a horseshoe 102 (see FIG. 6 showing assembly 100 attached to a horse's hoof 602). Assembly 100 will attach to most conventional horseshoes such as those made of steel, aluminum, titanium or other generally metallic alloys. Assembly 100 can also adhere to suitable non-metallic materials such as ABS, PVC and some epoxies, but generally not directly to vinyl or urethane materials.

Assembly 100 is a separate element from and not initially attached to horseshoe 102. That is, assembly 100 is distributed to end-user customers (such as a farrier) as a separate product. This will permit the end-user, to select the particular horseshoe of his/her choosing. Once a particular horseshoe having a particular shape and size configuration is selected by a farrier, the farrier may attach horseshoe 102 to assembly 100 using an adhesive, and then secure assembly 100 to a horse's hoof, by means of an adhesive.

As horseshoes come in a variety of different sizes, and different shape configurations, a farrier is able to adjust the size and shape configuration of assembly 100 to conform to the particular size/shape configuration of the selected horseshoe. For example, assembly 100 may be supplied in size configurations including small, medium, large, and extra large, to more easily meet a farrier's needs when selecting an assembly to match the size configuration of many different sized horseshoes. Adjustment in shape configuration of assembly 100 may be achieved by bending each of the U-shaped members of assembly 100 in a generally planar direction to match the shape/configuration of a horseshoe.

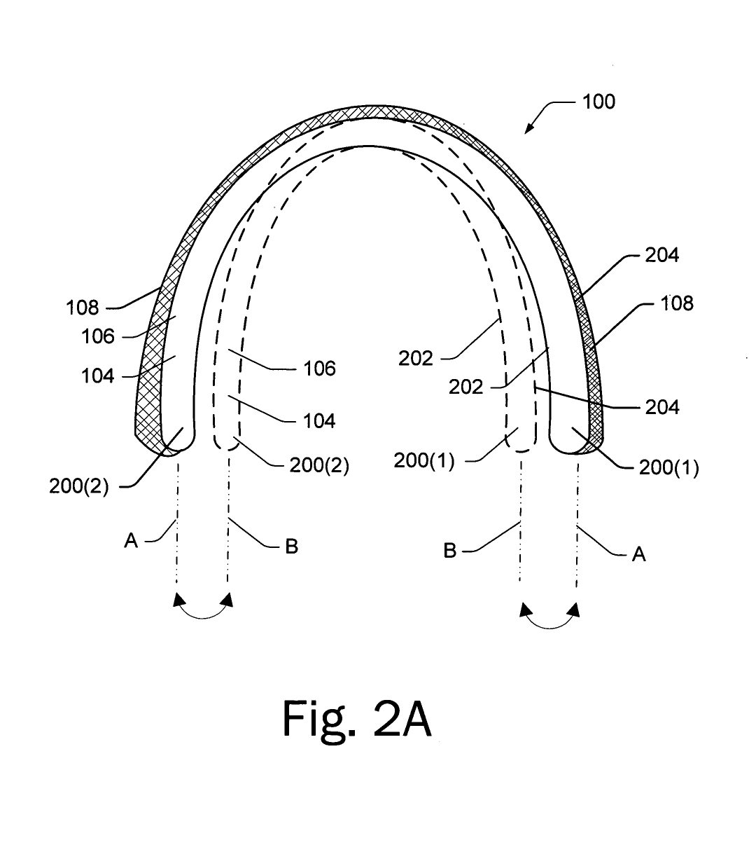

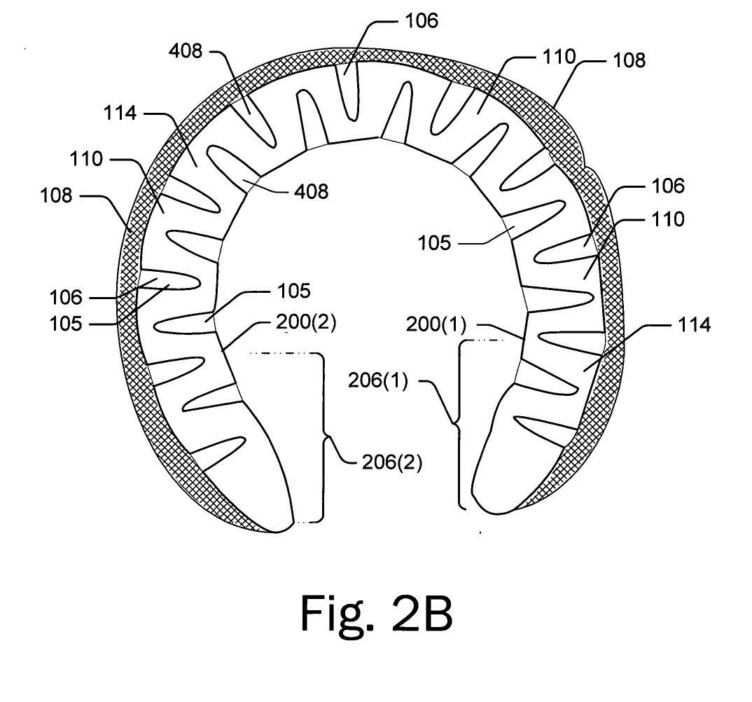

For example, FIG. 2A shows a top view of assembly 100. As shown in FIG. 2, two U-shaped members 200(1), 200(2) may be adjusted (e.g., bent) from a first fixed position A to a second fixed position B. Each U-shaped member may be moved inward toward each other or outward away from each other in a plurality of generally planar distances from each other.

Additionally, each U-shaped member 200(1), 200(2) may be bent such that each member is shaped to align and to conform to the boundaries of a selected horseshoe. For example, FIG. 2B shows a bottom view of a shape configuration for horseshoe assembly 100 in which U-shaped members 200 comprising assembly 100 are bent in a shape configuration to correspond with a horseshoe (not shown) that has a similar shape configuration. As shown in FIG. 2B each member 200(1), 200(2) is flared inward at locations 206(1), 206(2) to correspond with a horseshoe (not shown) that may have a similar configuration in shape. It is appreciated that this illustration is exemplary, and that the variety of different shapes and size configurations in which assembly 100 can match are practically unlimited.

Having introduced assembly 100, it is now possible to describe its constituent elements in more detail. Assembly 100 includes an elastomeric rim pad 106, a cuff 108, and a plate 110. Each shall now be described in more detail.

### Exemplary Rim Pad

As shown in FIGS. 1 and 2A, rim pad 106 has an upper surface 104 which is intended to be coextensive with an outer bottom periphery of a horse's hoof 602 (FIG. 6). That is, rim pad 106 is generally U-shaped to be complementary with the outer bottom periphery of a horse's hoof to support the bottom surface of the horse's hoof wall.

Rim pad 106 is formed of an elastomeric material that is flexible yet rigid enough to resist full deformation while maintaining shape integrity, such as a stiff rubber, a polymer, a polyurethane, or other durable flexible stress resistant material. In one embodiment, rim pad 106 is formed of TDI (toluene di-isocyante) urethane but could be any variety of suitable materials as would be appreciated by those skilled in the art after having the benefit of this disclosure. As used on horses, rim pad 106 is flexible upon compression providing a shock-absorbing feature, while not taking a compression set when the horse stands on it, thus reducing or eliminating shock experienced by a horse when in motion or in typical stride.

In one implementation, rim pad 106 has a thickness of about ¼ inch viewed from the side view of FIG. 1, and a width measured from an inner concave edge 202 (FIG. 2) to an outer convex edge 204 (FIG. 2) of about ¾ to one inch for a medium sized assembly. However, rim pad 106 may be thicker or thinner, and have widths that are wider or narrower depending on the size of the horse's hoof and the corresponding assembly.

### Exemplary Cuff

Rim pad 106 also secures cuff 108 to assembly 100. Cuff 108 is generally secured (i.e., attached) to rim pad 106. In one implementation, cuff 108 is incorporated in an upper portion of the rim pad 106. That is, cuff 108 is partly encapsulated in rim pad 106. Additional details of how cuff 108 is encapsulated in rim pad 106 are discussed in the above-mentioned U.S. Pat. No. 5,330,008, to Sigafoos et al. as well as U.S. Pat. No. 5,699,861 to Sigafoos, and U.S. Pat. No. 5,638,905 to Sigafoos et al., all incorporated fully herein by reference and will not be discussed further. Typically, cuff 108 extends from an outer convex edge 204 (FIG. 2A). It is noted that cuff 108 is not shown is position B of FIG. 2A to simplify the illustration, but in reality cuff 108 remains embedded in rim pad 106, and hence moves with rim pad 106 when assembly 100 is adjusted inwardly or outwardly.

In one embodiment, cuff 108 is a fabric configured to conform to a wall 604 (FIG. 6) of a horse's hoof 602 (FIG. 6) and attach thereto through the use of an adhesive. Cuff 108 may include several layers of fabric material. Cuff 108 may be used as a single ply or multi-ply layers. Each layer of material may be braided.

For example, in one implementation, cuff 108 is constructed of roughly equal quantities of polyester and Vectran™ (a liquid crystal polymer or polyester) graded in a two-ply configuration. Polyester is used to deliver high bonding strength with adhesive, is flexible, and works well in wet environments without structural weakening. However, other suitable materials may be selected in place of polyester, which provide similar attributes as polyester as would be appreciated by those skilled with the benefit of having this disclosure, such as nylon, and other synthetic or non-synthetic materials.

The second potential component of the braid, Vectran™, is used to provide abrasion resistance for cuff 108. The abrasion resistant material is incorporated to reduce and minimize the wear of the fabric due to contact with ground materials that a horse's hoof normally encounters, such as dirt, sand, gravel, etc. Other suitable abrasion resistant materials could be selected as would be appreciated by those skilled in the art having the benefit of this disclosure. For example, Dyneema® or Spectra® (high molecular weight polyethylene) or the like material could also be used as one of the ply material in place of, or in conjunction with, one of the plies.

Thus, cuff 108 may be constructed of strong and resistant material(s) able to undergo severe wear conditions.

Another aspect of cuff 108 is its ability to contact hoof wall 604 (FIG. 6). Horse's hooves are not uniform nor are the ground contact angles uniform from hoof to hoof. As a result of this factor, braided fabric may be used to fasten assembly 100 to a horse's hoof, because braided fabric is able to be contoured and shaped so that no wrinkles or folds occur when tightly bonding the cuff to the hoof wall. In one implementation this feature is achieved through the use of a type of braid used where the fibers are aligned at angles other than the typical 90° found in many woven fabrics. For instance, an angle of approximately between 30° and 50° has the added benefit of positioning the fibers on the hoof in a way that utilizes all of the fibers in holding a shoe onto the hoof, and supporting the hoof wall radially as with hoop stress. Other angles greater than 50° or less than 30° could be selected as well, but the least wrinkle free results were observed generally between 30° and 50°.

Thus, cuff 108 reinforces a hoof wall 604 (FIG. 6) and provides many benefits to a horse. For example, when implemented as fabric, cuff 108 bridges and stabilizes cracks in the hoof wall. It may also cover and rebuild a broken section of the hoof, support a thin, weak or shelly hoof wall and, also help to uniformly distribute load on the entire hoof wall. Additionally, using multiple layers of adhesive saturated fabric acts as a durable cover protecting the hoof from damage due to work in an on various surfaces the animal lives, works, and performs upon.

Typically, most adhesives such as methacrylate or other acrylic adhesive may be used for attaching cuff 108 and rim pad 106 to a horse's hoof. Please see U.S. Pat. No. 5,330,008, for a more detailed process of attaching cuff 108 to a horse's hoof.

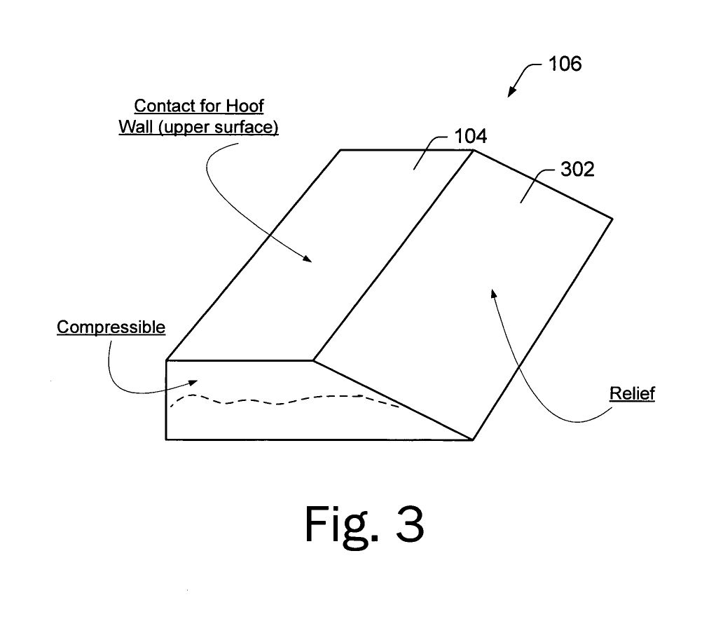

Returning back to the discussion of rim pad 106, FIG. 3 is an isometric view of a portion of rim pad 106. As shown in FIG. 3, rim pad 106 may also have an upper surface 104 and a concave relief section 302. Upper surface 104 provides support for the outer periphery of a horse's hoof, i.e., the bottom wall of the hoof. Concave relief section 304 of rim pad 106 prevents the upper surface 104 of rim pad 106 from contacting the thin and sensitive sole of the hoof.

### Exemplary Plate

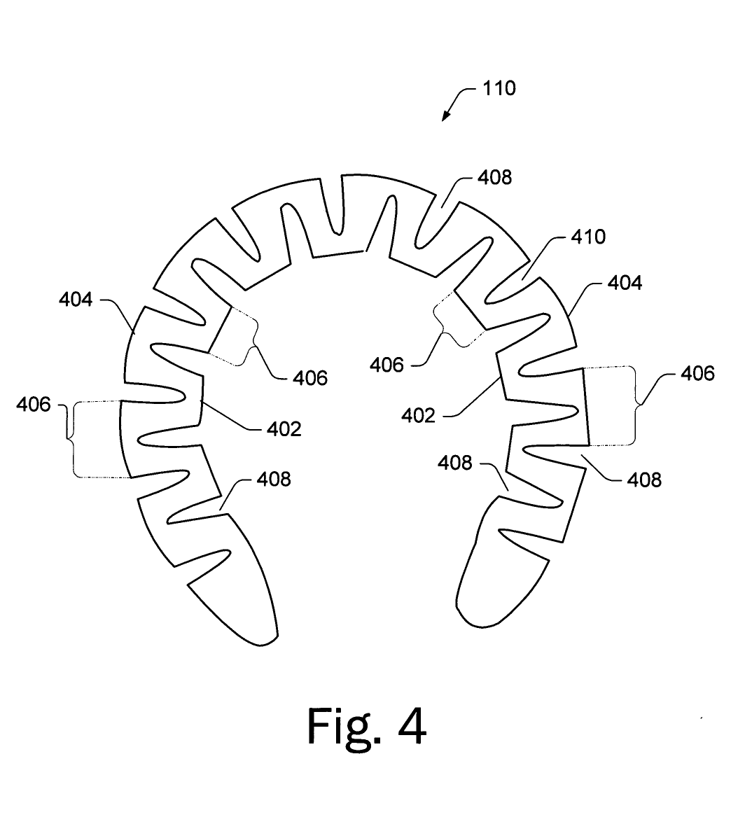

As shown in FIGS. 1 and 2B, plate 110 is secured to a lower surface 105 of elastomeric rim pad 106. In one implementation, plate 110 is bonded to elastomeric rim using a urethane bonding process described below. Plate 110 is generally a thin planar piece of material that serves as an interface between assembly 100 and a horseshoe 102. In one implementation, plate 110 is a thin planar material that has a thickness of about 1/16 of inch viewed from the side view of FIG. 1, and a width measured from an inner concave edge 402 (FIG. 4) to an outer convex edge 404 (FIG. 4) of about one inch for a medium sized assembly. However, plate 110 may be thicker (such as a ⅛ inch size, or thinner, and have widths that are wider or narrower depending on the size of the horse's hoof and the corresponding width of a horseshoe. In one embodiment, the width of plate 110 is generally coextensive with the width of rim pad 106.

FIG. 4 shows a top view of an exemplary implementation of plate 110. Plate 100 is formed of a bendable material which is adjustable in shape to conform in shape and size with a horseshoe selected from a group of horseshoes having different shapes and sizes. That is, a farrier can bend U-shaped assembly 100 to the make its two U-shaped members 200(1), 200(2) (FIGS. 2A and 2B) widen (e.g., move apart from each other) or narrow (e.g., move toward each other) in shape. Additionally, each U-Shaped member 200(1), 200(2) is adjustable in configuration so as to be able to match (conform) coextensively, the shape outline of a particular horseshoe. For example, some horseshoes taper or curve inward toward the back of the hoof, and plate 110 along with assembly 100 can be adjusted in shape to conform to that particular curve shaped configuration.

Plate 110 is formed of any material that is adjustable in configuration, such as through bending. In one embodiment, plate 110 is formed of aluminum. However, it is appreciated by those skilled in the art having the benefit of this disclosure, that plate 110 may be comprised of other suitable materials, such as metal composite, steel, or some combination of materials. As an interface between assembly 100 and a horseshoe 102 it is important that the type of material adhere to an adhesive material when plate 110 is attached to a horseshoe.

Generally, the bendable material of the plate 110 should have enough rigidity to retain a shape after an adjustment is made to its shape, including overcoming any counterforce exerted by the elastomeric rim pad 106 when flexed. Another preferable characteristic (although not required) is that plate 110 bend by hand without the use of applied heat which can degrade the bonds of elements comprising assembly 110.

To accomplish these goals, plate 110 may be segmented. For example, in one embodiment, plate 110 may include one or more slots 408 (FIGS. 2B. and 4) (and shown in FIG. 1 as reference number 116) on its inner edge 402 (FIG. 4) and/or outer edge 404 (FIG. 4). Separating each slot 408 is a non-slotted section 406 of plate 110 which is intact. This combination of slots 408 and non-slotted sections 406 forms the overall segmentation of plate 110, and provides a farrier with the ability to easily bend assembly 100 to match the shape configuration of a selected horseshoe. And once bent into a shape selected by the farrier, the overall segmentation of plate 110 also permits plate 110 to retain most shapes selected, while resisting the propensity of elastomeric rim pad 106 to return to its original cast shape after being flexed.

Segmentation of plate 110 also provides pockets 410 (in slots 408) between which viscous glue (acrylic or other adhesive) can flow to aid in attaching a horseshoe to assembly 100. These pockets 410 also serve as lateral friction points between the horseshoe and plate 110, after a horseshoe is attached to assembly 100 such as through the use of an acrylic adhesive when the adhesive cures.

Segmentation of plate 110 may be achieved using a variety of patterns, including slots, slits (not shown), holes (not shown), or any suitable combination of segmentation patterns, which are molded, forged, injected molded, stamped or cut into the plate 110, as would be appreciated by those skilled in the art having the benefit of this disclosure.

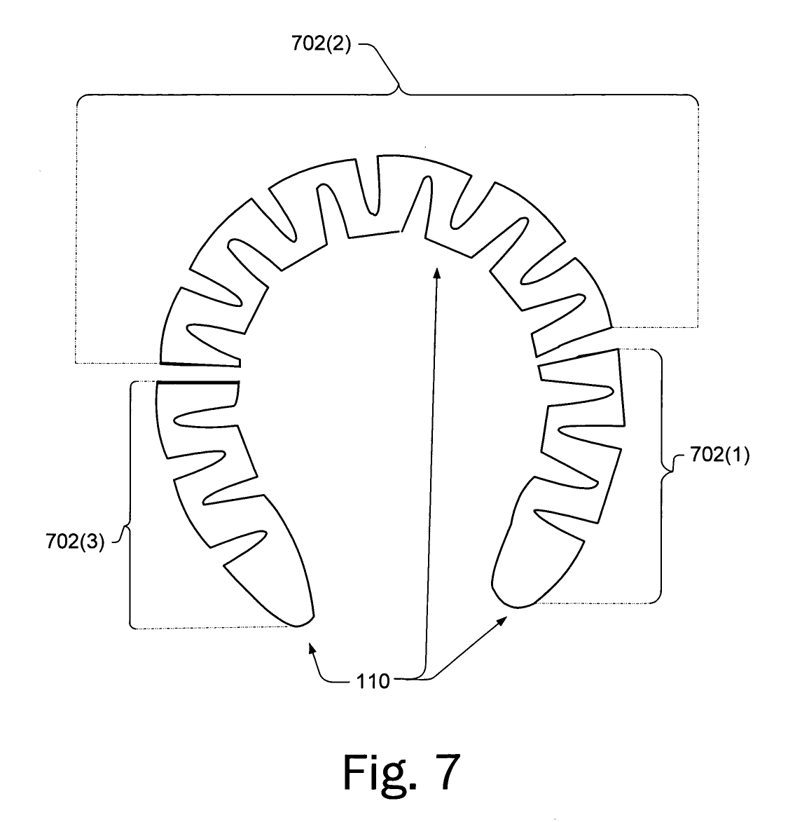

Additionally, plate 110 may include a plurality of independent sections instead of unitary piece of material. For example, FIG. 7 shows a top view of an exemplary implementation of plate 110 having three separate sections 702(1), 702(2), and 702(3) rather than a single unitary piece of material as shown in FIG. 4. Constructing plate 110 out of several sections of material (segments) may be helpful when constructing assembly 100 for larger hoofed animals, such as draft horses, as would be appreciated by those skilled in the art.

Thus, plate 100 is formed of a bendable material which is adjustable in shape to conform in shape and size with a horseshoe selected from a group of horseshoes having different shapes and sizes.

As shown in FIGS. 1 and 2B, plate 110 includes an upper surface 112 bonded to a bottom surface 105 of rim pad 106. Additionally, plate 110 includes a lower surface 114 for securing to an upper surface 103 (FIG. 1) of horseshoe 102 (FIG. 1). The overall manufacture process for assembly 100 may be achieved as follows:
1) Grit blast upper surface 112 of plate 110 using an aluminum oxide grit;
2) Coat plate 110 with an appropriate primer (such as Lord Chemlock™ 219 primer from Lord Corporation of Erie, Pa.);
3) Allow primer to air dry;
4) Coat the primed surface with an appropriate urethane material (such as Lord Chemlock™ 213);
4) Allow urethane material to air dry;
5) Heat plate 110 to approximately 200° Fahrenheit;
6) Heat the casting mold for rim pad 106 to approximately 2250° Fahrenheit;
7) Cut and place a piece of the braided cuff fabric on the upper casting mold;
8) Place the heated, prepared plate 110 in the lower mold;
9) Prepare the urethane pre-polymer by heating to approximately 250° Fahrenheit (such as a TDI material);
10) Heat the urethane hardener to approximately 250° Fahrenheit (we use a TDI compatible material);
11) Mix the urethane components and pour into mold to form rim pad 106;
12) Maintain heat on mold while the urethane gells and hardens (approximately 10-15 minutes);
13) De-mold the finished piece and trim the flash &/or sprues;
14) Cure the finished piece for 8-16 hours at approximately 200° Fahrenheit; and
15) Cool to room temperature.

The steps described above are exemplary, and that other processes can be used to construct an assembly 100, as would be appreciated by those skilled in the art having the benefit of this disclosure.

### Exemplary Method of Securing the Horseshoe Assembly to a Horseshoe

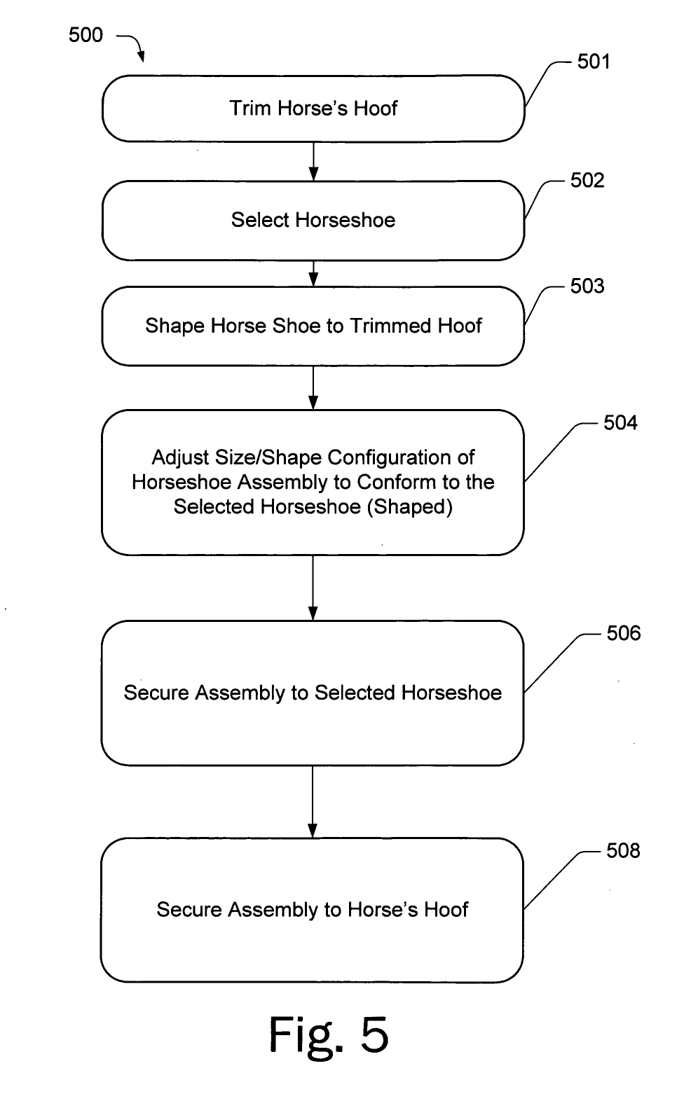

FIG. 5 shows a method 500 for attaching a horseshoe assembly to a horseshoe. Method 500 includes blocks 501, 502, 503, 504, 506, and 508. Each block of method 500 represents an operational step. It is appreciated that certain operational steps may be omitted, additional operation steps not shown added, or the exact order of steps may be performed differently.

In block 501, a horse's hoof wall is trimmed.

In block 502, a horseshoe is selected having a particular size and shape configuration.

In block 503, the selected horseshoe is fitted to the trimmed hoof.

In block 504, the assembly 100 is bent (see FIG. 2) in shape to adjust its size and shape configuration to match the particular size and shape configuration of the horseshoe selected in block 502 as it may have been shaped in block 503.

In block 506, assembly 100 is secured to a horseshoe 102 (see FIG. 6). For example, an adhesive such as an acrylic adhesive (shown as arrow 606 in FIG. 6) is applied to an upper surface 103 (FIG. 1) of the horseshoe 102 (FIG. 1) and lower surface 114 (FIG. 1) of horseshoe assembly 100. It is noted that where there gaps such as slots 408 (FIG. 4) or pockets 410 (FIG. 4), the lower surface of assembly 100 is lower surface 105 of rim pad 106. The lower surface 105/114 (FIG. 1) of the horseshoe assembly is contacted with upper surface 103 (FIG. 1) of the horseshoe 102 which allows horseshoe assembly 100 to bond to the horseshoe 102.

In block 508, assembly 100 with a horseshoe 102 secured thereto may be attached to the horse's hoof using an adhesive, such as an acrylic material. For example, cuff 108 and rim pad 106 can be applied to a horse's hoof by using an acrylic adhesive.

FIG. 6 shows a side view of assembly 100 secured to a horse's hoof. In order to secure the cuff, a horse's hoof should first be prepared using a rasp or file in the same way in which it would be prepared for a conventional shoe and the fabric cuff should be trimmed as necessary.

Prior to application of the shoeing system, the outside of the hoof wall should be coated with a thin layer of an acrylic adhesive where the fabric of cuff 108 will contact the hoof. Immediately after this, the fabric cuff portion of the assembly must be saturated with the same adhesive before attachment to the outside periphery of the hoof wall. A moderately fast-curing methacrylate-based structural adhesive is recommended. Two-part 100% reactive methacrylate-based structural adhesives are preferred since they are strong, can be very fast setting, and their acrylic properties allow the adhesives to attach to the proteinaceous hoof wall of the animal with a strong bond, while also adhering strongly to the polymeric fabrics as used in the cuff part of the horseshoe assembly. Note: there is no glue applied to the bottom of the horse's hoof; the entire attachment strength is derived from the cuff in shear bonding to the outside wall of the horse's hoof

Versilok 402 from Lord Corporation of Erie, Pa. is an excellent modified acrylic structural adhesive for this purpose. It is based on methyl-2-methyl-2-propenoate (methyl methacrylate) with an accelerator of benzoyl peroxide, diisobutyl phthalate, and a bisphenol. While Versilok 402 is useful, it is somewhat tacky even when fully cured. Versilok 403 is less tacky while providing the necessary strength but is slower curing than Versilok 402. Either adhesive is effective when used in the present invention as are other fast-setting acrylic adhesives.

Cuff 108 is then set onto the hoof, as shown in FIG. 6. The open (working) time for the fast-curing acrylic adhesive (Versilok 402) is approximately two to four minutes. After this, the horse's hoof with the shoe assembly is wrapped tightly with a thin stretchable material (like a stretch wrap or a vet wrap) and can be placed back on the ground. The total time the farrier (horse-shoer) is holding the hoof off the ground is about 1-2 minutes to apply the system, smooth the cuff and wrap. The slower setting adhesive should cure in about eight to ten minutes which allows time for some smoothing of fabric cuff 108 thru the stretched wrap after the hoof has been set back on the ground. No further adjustments will be necessary and the adhesive will achieve full strength in about two hours after which the horse may be led through its normal routine. Cuff 108 provides a strong and durable, non-invasive covering which protects the horse's hoof.

Thus, the horseshoe assembly in accordance with the present invention therefore provides a farrier with the ability to assess a horse's hoof, select a shoe shape, select a shoe size, and then attach the assembly thereto simply by adjusting the assembly in size and shape to conform with the selected horseshoe, and glue the horseshoe and assembly together on site.

It is to be understood that the present invention is not limited to the embodiments described above, but encompasses any and all embodiments within the scope of the subjoined Claims and their equivalents.

What is claimed is:

1. An assembly for attaching a horse's hoof to a horseshoe, the assembly comprising:
an elastomeric rim pad adjustable in shape for securing to a horse's hoof;
a cuff secured to the elastomeric rim pad, configured to conform to a wall of a horse's hoof and attach thereto through the use of an adhesive; and
a planar plate, secured to a lower surface of the elastomeric rim pad, the plate comprised of a bendable material which is adjustable in shape to conform in shape and size with a horseshoe selected from a group of horseshoes having different shapes and sizes.

2. The assembly as recited in claim 1, wherein the bendable material adheres to an adhesive material.

3. The assembly as recited in claim 1, wherein the bendable material is formed of at least one of a metal composite, aluminum, steel, ABS and PVC.

4. The assembly as recited in claim 1, wherein the bendable material of the plate has enough rigidity to retain a shape after an adjustment is made to its shape, including overcoming any counterforce exerted by the elastomeric rim pad when flexed.

5. The assembly as recited in claim 1, wherein the elastomeric rim pad has an upper surface that is generally coextensive with an outer bottom periphery of a horse's hoof after the elastomeric rim pad is adjusted in shape; and wherein the elastomeric rim pad is formed of at least one of rubber, polyurethane, and urethane.

6. The assembly as recited in claim 1, wherein the cuff is formed of a braided fabric.

7. The assembly as recited in claim 1, wherein the cuff is formed of a braided fabric formed of a polyester fiber and an abrasion resistant material.

8. The assembly as recited in claim 1, wherein the cuff is formed of a braided fabric that contains fibers aligned at angles other than 90 degrees between approximately 30° and 50°.

9. The assembly as recited in claim 1, wherein the plate is segmented.

10. The assembly as recited in claim 1, wherein the plate is bendable by hand without the use of applied heat.

11. The assembly of claim 1, wherein at least one of the elastomeric rim pad and the plate are comprised of one or more separate sections forming a single unitary unit which is generally U-shaped.

12. An interface for securing a horseshoe to a hoof assembly, the interface comprising: a U-shaped plate being generally planar and having an upper surface for securing to the hoof assembly, and a lower surface for securing to the horseshoe, wherein the plate is comprised of a bendable material which is adjustable in shape to be coextensive with a selected horseshoe.

13. The interface as recited in claim 12, wherein the U-shaped plate includes a curved outer peripheral edge that has one or more slots formed therein.

14. The interface as recited in claim 12, wherein the U-shaped plate includes a curved inner peripheral edge that has one or more slots formed therein.

15. The interface as recited in claim 12, wherein the U-shaped plate includes holes that pass from the upper surface of the plate to the lower surface of the plate.

16. The interface as recited in claim 12, wherein the U-shaped plate includes one or more segmented sections.

17. An article, comprising:
a glue-on assembly for attachment to a horse's hoof through the use of adhesive comprising a U-shaped elastomeric rim pad having an upper surface coextensive with an outer bottom periphery of a horse's hoof;
a cuff secured to the elastomeric rim pad; and
a U-shaped plate having a lower surface for attachment to a horseshoe, the U-shaped plate having an upper surface secured to a lower surface of the U-shaped elastomeric rim pad, the U-shaped plate comprised of a bendable material which (i) is adjustable in shape to conform in shape and size with a selected horseshoe from a group of horseshoes having different shapes and sizes and (ii) adheres to adhesive materials.

18. The article as recited in claim 17, further comprising a horseshoe secured to the lower surface of the U-shaped plate by an adhesive.

19. A method for attaching a horseshoe assembly to a horseshoe, the horse shoe assembly having an upper surface for attachment to a horse's hoof through the use of an adhesive, and a lower surface for attachment to the horseshoe, the method comprising:
selecting a horseshoe having a particular size and shape configuration;
adjusting the horseshoe assembly's size and shape to conform to the particular size and shape configuration of the horseshoe; and
securing the horseshoe assembly to the horseshoe.

20. The method as recited in claim 19, further comprising using an adhesive to attach the horseshoe assembly to an outer periphery of a horse's hoof wall after the horseshoe assembly bonds to the horseshoe.

21. The method as recited in claim 19, wherein the horseshoe assembly comprises an elastomeric rim pad, a fabric cuff incorporated in an upper portion of the elastomeric rim pad, and a plate, secured to a lower surface of the elastomeric rim pad.

22. The method as recited in claim 19, wherein securing the horseshoe assembly to the horseshoe includes applying an adhesive to at least one of an upper surface of the horseshoe and the lower surface of the horseshoe assembly; and contacting the lower surface of the horseshoe assembly to the upper surface of the horseshoe which allows the horseshoe assembly to complete a bond to the horseshoe.
